(19) United States
(12) Patent Application Publication
(10) Pub. No.: US 2025/0028494 A1
(43) Pub. Date: Jan. 23, 2025

(54) MULTIPLE DISPLAY CONFIGURATION TECHNIQUE

(71) Applicant: International Business Machines Corporation, Armonk, NY (US)

(72) Inventors: Mohamed Zouhaier Ramadhane, Azcapotzalco (MX); Jazmin Rodriguez Aguilera, Zapopan (MX); Jonathan Oswaldo Lara Dominguez, Guadalajara (MX); Daniela Ofelia Rojas Barrientos, Naucalpan de Juarez (MX)

(73) Assignee: International Business Machines Corporation, Armonk, NY (US)

(21) Appl. No.: 18/225,136

(22) Filed: Jul. 23, 2023

(51) Int. Cl. G06F 3/14; G06F 3/00

(52) U.S. Cl. CPC G06F 3/1423; G06F 3/002; G09G 2360/04

(57) ABSTRACT

A method for configuring multiple displays connected to a common computing system is disclosed. In one embodiment, a computing system detects multiple displays connected thereto. The computing system causes at least one of the displays to emit a lighting pattern. This lighting pattern may include, for example, sequentially displaying a selected background color and/or pattern on each of the displays. The computing system detects the lighting pattern using one or more cameras connected to the computing system, such as cameras incorporated into the displays. Using the detected lighting pattern, the computing system infers a physical arrangement of the displays. In certain embodiments, the computing system uses artificial intelligence to infer the physical arrangement. A corresponding system and computer program product are also disclosed herein.

### BACKGROUND

### Field of the Invention

This invention relates to displays and more specifically to techniques for configuring multiple displays connected to a common computing system.

### Background of the Invention

As high quality displays (e.g., computer monitors, screens, etc.) become more affordable, multiple displays are frequently used together to achieve a larger display area or to extend the functionality of mobile devices such as laptops, tablets, and cell phones. Some studies show a dramatic increase in productivity when multiple displays are used. In some cases, companies may join a number of smaller displays together to create large digital billboards, banners, and signage. In such applications, it is important that the multiple displays be configured correctly to allow them to work together and to enable images to be smoothly distributed across the multiple displays and to enable graphical elements (mouse pointers, windows, etc.) to smoothly move from one display to another.

Nevertheless, the configuration of these displays is not always static. In some cases, a display may be moved from one computing system to another, displays may be physically rearranged, or a display may be added to or removed from an existing computing system. Each time this occurs, the displays may need to be reconfigured so that they work together correctly and so that a computing system to which the displays are connected understands the physical arrangement of the displays in the real world. This may enable images and graphical elements to be accurately displayed on the multiple displays as well as enable these same elements to be moved between the displays in a visually appealing manner.

### SUMMARY

The invention has been developed in response to the present state of the art and, in particular, in response to the problems and needs in the art that have not yet been fully solved by currently available systems and methods. Accordingly, systems and methods have been developed to more effectively configure multiple displays connected to a common computing system. The features and advantages of the invention will become more fully apparent from the following description and appended claims, or may be learned by practice of the invention as set forth hereinafter.

Consistent with the foregoing, a method for configuring multiple displays connected to a common computing system is disclosed. In one embodiment, a computing system detects multiple displays connected thereto. The computing system causes at least one of the displays to emit a lighting pattern. This lighting pattern may include, for example, sequentially displaying a selected background color and/or pattern on each of the displays. The computing system detects the lighting pattern using one or more cameras connected to the computing system, such as cameras incorporated into the displays. Using the detected lighting pattern, the computing system infers a physical arrangement of the displays. In certain embodiments, the computing system uses artificial intelligence to infer the physical arrangement.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIGS. 2 through 4 show a first technique for detecting a relative position of displays along an X axis;

FIGS. 5 and 6 show a second technique for detecting a relative position of displays along a Y axis;

FIG. 7 is a process flow diagram showing one embodiment of a method for configuring multiple displays connected to a common computing system;

FIG. 8 is a process flow diagram showing another embodiment of a method for configuring multiple displays connected to a common computing system; and

FIG. 9 is a high-level diagram showing X and Y axes in relation to the displays.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “display configuration module 150”) for configuring multiple displays connected to a computing system. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

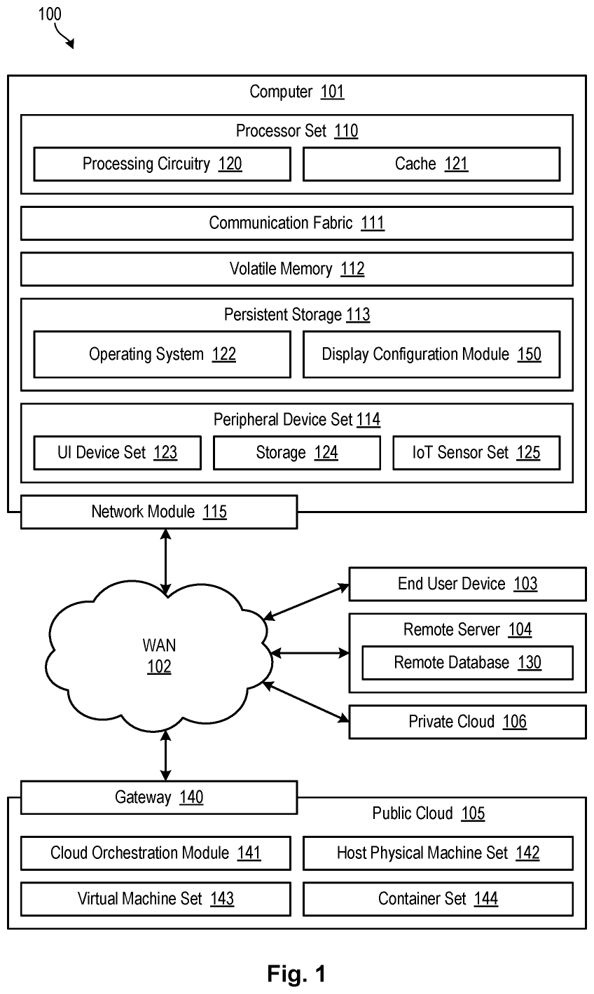

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

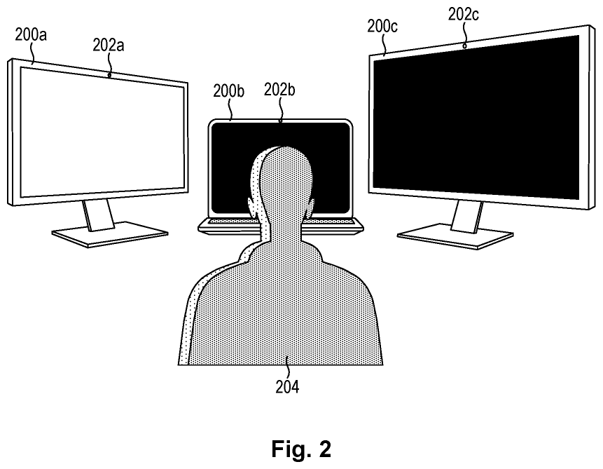

Referring to FIG. 2, as previously mentioned, when multiple displays are used, it is important that the displays be configured correctly to allow them to work together and to enable images to be smoothly distributed across the multiple displays and to enable graphical elements (mouse pointers, windows, etc.) to smoothly move from one display to another. This configuration is subject to change. For example, a display may be moved from one computing system to another, displays may be physically rearranged, or a display may be added to or removed from an existing computing system. Each time this occurs, the displays may need to be reconfigured so that they work together correctly and so that a computing system to which the displays are connected understands the physical arrangement of the displays in the real world. This may enable images and graphical elements to be accurately displayed on the multiple displays as well as enable these same elements to be moved between the displays in an accurate and visually appealing manner. Thus, it would be an advance in the art to provide techniques and associated functionality to quickly and seamlessly configure multiple displays connected to a computing system.

In order to quickly and seamlessly configure multiple displays connected to a computing system, systems and methods in accordance with the invention may perform a series of steps that, when combined with artificial intelligence, may be used to determine a physical arrangement of displays in the real world so that the displays can be properly configured on the computing system. In certain embodiments, the series of steps may be divided into a first series of steps that may be designed to detect a physical arrangement of the displays along an X (i.e., horizontal) axis, and a second series of steps that may be designed to detect a physical arrangement of the displays along a Y (i.e., vertical) direction. In other embodiments, the steps may be combined to simultaneously detect a physical arrangement in both the X and Y axes.

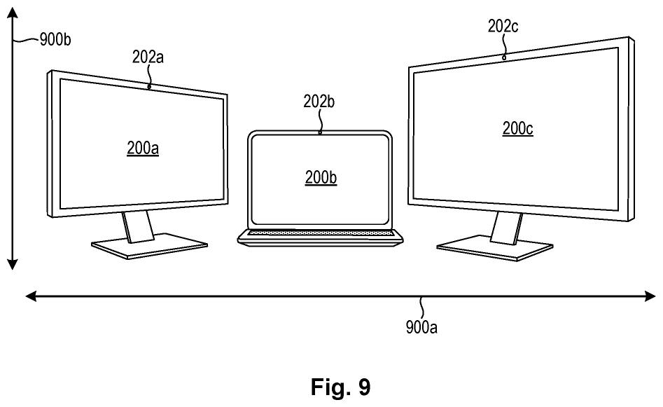

FIGS. 2 through 4 show a first technique for detecting a relative position of displays along an X axis 900a (FIG. 9 shows the X axis 900a in relation to the displays 200a-c). Advantageously, this technique may be performed without user invention using only the displays themselves as well as one or more cameras that are integrated into the displays or potentially even separate from the displays but in communication with a computing system. As shown, the technique may, in certain embodiments, involve setting a background color on all the displays to black or other dark color and then illuminating each of the displays, one by one, to emit a lighting pattern in front of the displays. In certain embodiments, the brightness of an illuminated display may be turned up or maximized. This may cast shadows or provide other illumination in front of the displays. The one or more cameras may detect the illumination pattern and potentially capture the illumination pattern in the form of one more images. Artificial intelligence may then be used to interpret the illuminated light patterns detected and/or captured by the cameras to determine where the illumination originates and thereby determine where the emitting displays are located relative to other displays connected to the computing system.

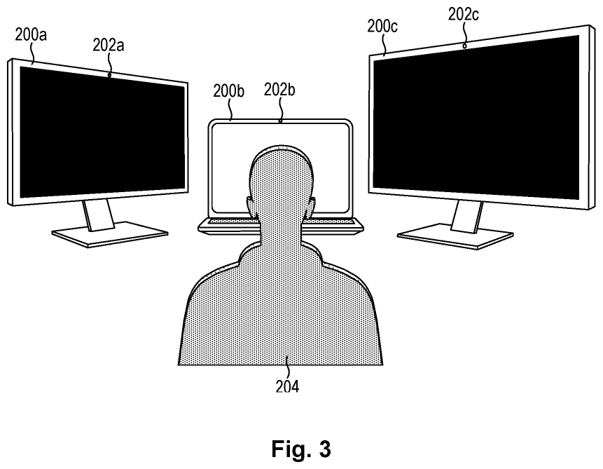

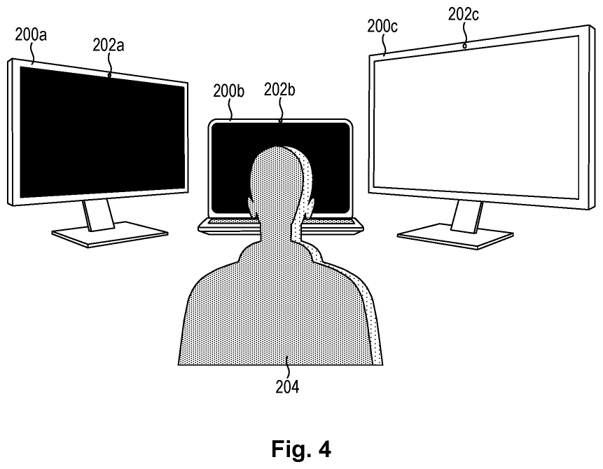

For example, FIG. 2 shows a left-most display 200a (from the point-of-view of a user 204) fully illuminated with a white screen at maximum brightness, while the other displays 200b, 200c present a black background. One or more cameras 202a-c may detect the illumination pattern emanating from the left-most display 200a and optionally capture it as an image for analysis by artificial intelligence. Similarly, FIG. 3 shows a center display 200b fully illuminated with a white screen at maximum brightness, while the other displays 200a, 200c present a black background. The cameras 202a-c may detect the illumination pattern emanating from the center display 200b and optionally capture it as an image for analysis by the artificial intelligence. FIG. 4 shows a right-most display 200c fully illuminated with a white screen at maximum brightness, while the other displays 200a, 200b present a black background. The cameras 202a-c may detect the illumination pattern emanating from this display 200c and optionally capture it as an image for analysis by the artificial intelligence.

As mentioned above, the illumination pattern emitted from each display 200a-c may be analyzed by artificial intelligence to determine where the displays 200a-c are positioned relative to one another along the X-axis 900a. The illumination pattern may be incident on items such as furniture, keyboards, computer mice, walls, chairs, etc. in front of the displays 200a-c, and even potentially a user 204. In certain embodiments, the artificial intelligence is trained with images and associated illumination patterns generated from other computing systems where the positions of the displays 200a-c along the X-axis 900a were known. This may enable the artificial intelligence to accurately determine or infer the positions of displays 200a-c along the X-axis 900a simply by looking at images and associated illumination patterns captured or detected during the process illustrated in FIGS. 2 through 4, thereby eliminating or reducing the need for a user to manually configure the displays 200a-c.

It should be recognized that the technique shown in FIGS. 2 through 4 represents just one example of a lighting pattern that may be emitted from the displays 200a-c for the purpose of determining their positions and is not intended to be limiting. For example, in other or the same embodiments, different colors may be emanated from the displays 200a-c, or different patterns or levels of brightness on the displays 200a-c, in order to determine their relative positions. In other embodiments, lighting patterns may be dynamic rather than static, with changing lighting patterns such as moving, flashing, or changing visual elements, colors, levels of brightness, or the like.

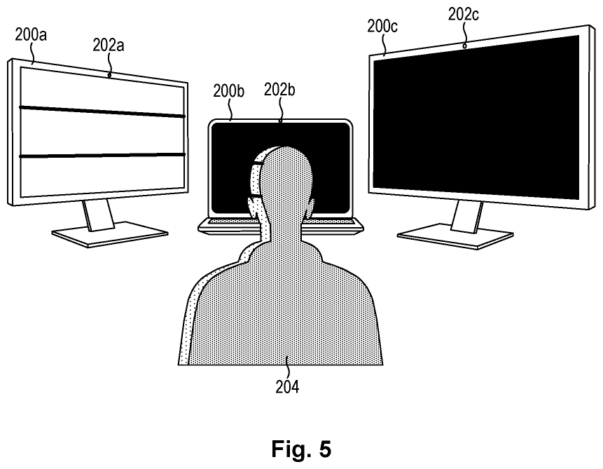

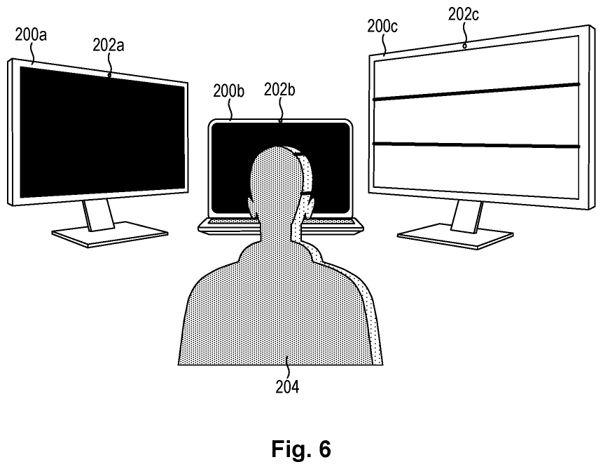

FIGS. 5 and 6 show a second technique for detecting a relative position of displays along a Y axis 900b (FIG. 9 shows the Y axis 900b in relation to the displays 200a-c). For example, FIG. 5 shows a left-most display 200a fully illuminated with a white screen at maximum brightness, while the other displays 200b, 200c present a black background. Horizontal dark lines are depicted on the left-most display 200a. One or more cameras 202a-c may detect the illumination pattern emanating from the left-most display 200a including where the lines are projected onto external objects in order to, using artificial intelligence, estimate a position of the left-most display 200a along the Y axis 900b. Similarly, FIG. 6 shows a right-most display 200c fully illuminated with a white screen at maximum brightness while the other displays 200a, 200b present a black background. Horizontal dark lines are depicted on the right-most display 200c. The one or more cameras 202a-c may detect the illumination pattern emanating from the right-most display 200c including where the lines are projected in order to estimate a position of the right-most display 200c along the Y axis 900b. The same process may also be performed for the center display 200b.

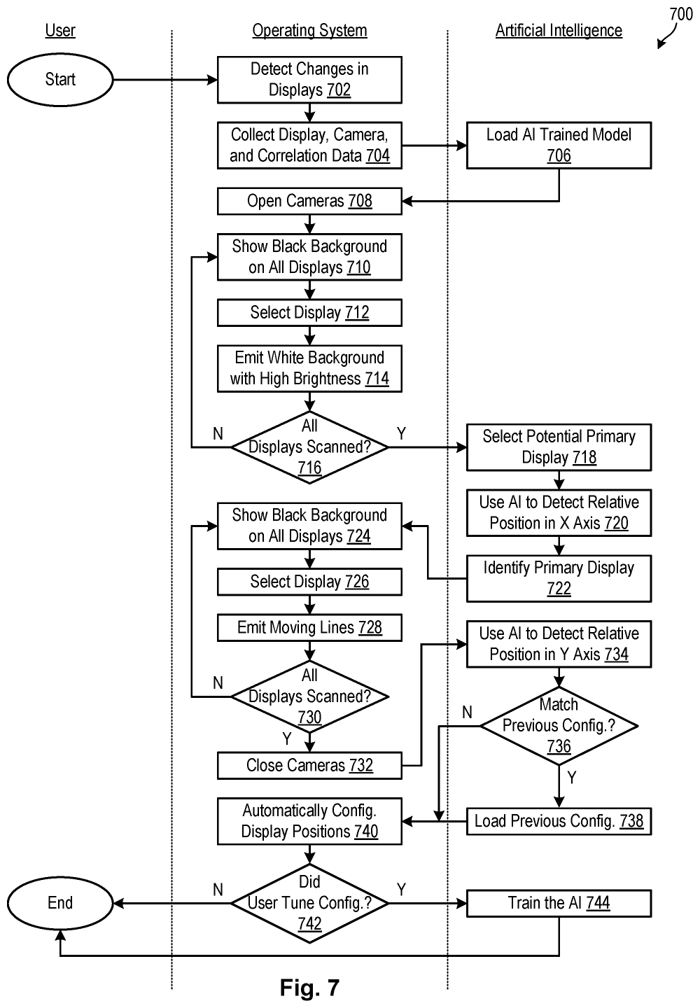

Referring to FIG. 7, one embodiment of a method 700 for configuring multiple displays 200a-c connected to a common computing system is illustrated. The method 700 is divided into three separate columns depending on the actor (i.e., the user, operating system, and artificial intelligence) that performs the illustrated steps, although the steps are not necessarily limited to execution by the illustrated actors.

As shown, the method 700 initially detects changes to displays 200a-c connected to a computing system. These changes may include, for example, moving a display 200 from one computing system to another, physically rearranging displays 200a-c, or adding or removing a display 200 from an existing computing system. When such changes are detected, the method 700 collects display 200, camera 202, and correlation data (e.g., which camera belongs to which display 200 if integrated with the display 200). Data collected for displays 200a-c may include, for example, the number, type, brand, resolution, ports, current configuration, and/or capabilities to control settings such as a display's brightness. Collected data may also include camera information such as type, brand, quantity, resolution, ports, etc. associated with the cameras 202a-c. The method 700 then loads 706 an artificial intelligence model that is trained to configure the displays 200a-c.

The method 700 may then open the cameras 202a-c to detect or capture images and other information. The method 700 shows 710 a black background (preferably with brightness turned down) on each of the displays 200a-c and selects 712 a display 200 from the set of displays 200a-c that has not yet been scanned. On this selected display 200, the method 700 emits 714 a lighting pattern, in this example a white background with high brightness. The illumination effects of this lighting pattern on surrounding elements (e.g., furniture, keyboards, mice, walls, chairs, users) etc. is detected and/or captured by the cameras 202a-c. This process may repeat for all displays 200a-c in the group as was discussed in association with FIGS. 2 through 4 until all displays 200a-c have been scanned at step 716.

The method 700 then selects 718 a potential primary display 200 from the group of displays 200a-c based on collected and historical configuration data. For example, if the computing system on which the operating system is running is a laptop and the laptop has a built-in screen, this screen may selected as the potential primary display 200. The method 700 then uses the artificial intelligence to detect 720 the relative position of the displays 200a-c along the X axis 900a. Since light projected from the displays 200a-c is incident on objects in front of the displays 200a-c, the artificial intelligence may be trained to determine the position of each display 200 relative to a primary display 200 in the X axis 900a. The method 700 may then identify 722 the primary display 200 based on the position of the detected displays 200a-c and user history. For example, if there is one internal and two external displays 200a-c, the method 700 may assume the internal display is the primary display 200. However, if one of a group of displays 200a-c is determined to be in a center position and a user typically selects the center display 200 as the primary display 200, then the center display 200 may be selected as the primary display 200.

At this point the method 700 once again shows 724 a black background on each of the displays 200a-c and selects 726 a display 200 from the set of displays 200a-c. On this selected display 200, the method 700 emits 714 moving lines on a white background with high brightness, as shown in FIGS. 5 and 6. The illumination effects of this lighting pattern on surrounding elements (e.g., furniture, keyboards, mice, walls, chairs, users) etc., including a position of the lines projected thereon, is detected and/or captured by the cameras 202a-c. This process may repeat for all displays 200a-c in the group as was discussed in association with FIGS. 5 and 6 until all displays 200a-c have been scanned at step 730. The method 700 then closes 732 the cameras 202a-c.

The method 700 then uses 734 the artificial intelligence to determine a relative position of the displays 200a-c along the Y axis 900b. Since light projected from the displays 200a-c is incident on objects in front of the displays 200a-c, the artificial intelligence may be trained to detect the relative position of each display 200 along the Y axis 900b by analyzing the light patterns.

The method 700 then determines 736 whether the detected positions of the displays 200a-c along the X and Y axes 900a, 900b matches a previous configuration of the displays 200a-c (i.e., a previous configuration may include a same type, number, position, interface used, model, etc. for the displays 200a-c). If so, the method 700 loads 738 the previous configuration and configures the displays 200a-c in accordance with previous configuration. If no match is found, the method 700 automatically configures 740 the displays 200a-c in accordance with the data that was collected for the displays 200a-c and the positions determined by the artificial intelligence. At this point, the method 700 determines 742 whether the user tuned the configuration (e.g., changed or adjusted the configuration, such as changed positions, the primary display, etc.) established by the artificial intelligence. If so, the method 700 trains the artificial intelligence to learn the user's preferences regarding the displays' configuration and/or more accurately determine the displays' positions.

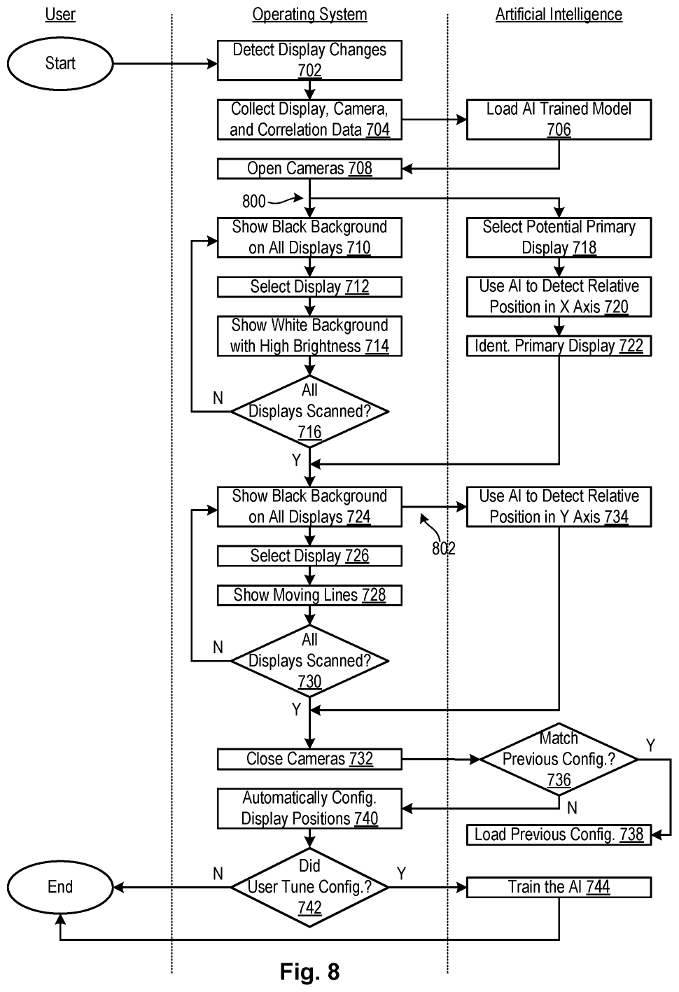

FIG. 8 shows the same method 700 as FIG. 7 except that the artificial intelligence functionality is executed in parallel with the display scanning functionality. That is, the artificial intelligence steps 718, 720, 722 for detecting a position of the displays 200a-c along the X axis 900a is performed in parallel with the display scanning steps 710, 712, 714, 716, and the artificial intelligence step 734 for detecting a position of the displays 200a-c along the Y axis 900b is performed in parallel with the display scanning steps 724, 726, 728, 730. To accomplish this, the method 700 may split into parallel paths at points 800, 802.

Various different modifications or alterations to the method 700 of FIGS. 7 and 8 are possible and within the scope if invention. For example, in another embodiment, to more accurately determine positions of the displays 200a-c in the X and Y axes 900a, 900b, an additional step may be implemented where the displays 200a-c show vertical lines, moving circles, or any light high contrast animation that can enable the positions of the displays 200a-c to be determined. In another embodiment, particularly where the artificial intelligence is well trained, the method 700 may be modified to detect positions of the displays 200a-c in the X and Y directions by showing, on the displays 200a-c sequentially, moving lines that are out of phase. In yet another embodiment, particularly where the artificial intelligence is well trained, the method 700 may be modified to detect positions of the displays 200a-c in the X and Y directions by showing, on the displays 200a-c at the same time, moving lines that are out of phase.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for configuring multiple displays connected to a common computing system, the method comprising:
detecting, by a computing system, a plurality of displays connected thereto;
causing, by the computing system, at least one of the plurality of displays to emit a lighting pattern;
detecting, by the computing system, the lighting pattern using at least one camera connected to the computing system; and
inferring, by the computing system, a physical arrangement of the plurality of displays from the detected lighting pattern.

2. The method of claim 1, wherein the lighting pattern comprises sequentially displaying a selected background color and/or pattern on each of the plurality of displays.

3. The method of claim 1, wherein the lighting pattern comprises a first lighting pattern to infer relative horizontal positions of the plurality of displays, and a second lighting pattern to infer relative vertical positions of the plurality of displays.

4. The method of claim 1, wherein the at least one camera is physically incorporated into at least one of the plurality of displays.

5. The method of claim 1, wherein inferring the physical arrangement comprises using artificial intelligence to infer the physical arrangement.

6. The method of claim 5, further comprising enabling a user to manually tune the inferred physical arrangement.

7. The method of claim 6, further comprising using the manual tuning of the user to further train the artificial intelligence.

8. A computer program product for configuring multiple displays connected to a common computing system, the computer program product comprising a computer-readable storage medium having computer-usable program code embodied therein, the computer-usable program code configured to perform the following when executed by at least one processor:
detect, by a computing system, a plurality of displays connected thereto;
cause, by the computing system, at least one of the plurality of displays to emit a lighting pattern;
detect, by the computing system, the lighting pattern using at least one camera connected to the computing system; and
infer, by the computing system, a physical arrangement of the plurality of displays from the detected lighting pattern.

9. The computer program product of claim 8, wherein the lighting pattern comprises sequentially displaying a selected background color and/or pattern on each of the plurality of displays.

10. The computer program product of claim 8, wherein the lighting pattern comprises a first lighting pattern to infer relative horizontal positions of the plurality of displays, and a second lighting pattern to infer relative vertical positions of the plurality of displays.

11. The computer program product of claim 8, wherein the at least one camera is physically incorporated into at least one of the plurality of displays.

12. The computer program product of claim 8, wherein inferring the physical arrangement comprises using artificial intelligence to infer the physical arrangement.

13. The computer program product of claim 12, wherein the computer-usable program code is further configured to enable a user to manually tune the inferred physical arrangement.

14. The computer program product of claim 13, wherein the computer-usable program code is further configured to use the manual tuning to further train the artificial intelligence.

15. A system for configuring multiple displays connected to a common computing system, the system comprising:
at least one processor;
at least one memory device operably coupled to the at least one processor and storing instructions for execution on the at least one processor, the instructions causing the at least one processor to:
detect, by a computing system, a plurality of displays connected thereto;
cause, by the computing system, at least one of the plurality of displays to emit a lighting pattern;
detect, by the computing system, the lighting pattern using at least one camera connected to the computing system; and
infer, by the computing system, a physical arrangement of the plurality of displays from the detected lighting pattern.

16. The system of claim 15, wherein the lighting pattern comprises sequentially displaying a selected background color and/or pattern on each of the plurality of displays.

17. The system of claim 15, wherein the lighting pattern comprises a first lighting pattern to infer relative horizontal positions of the plurality of displays, and a second lighting pattern to infer relative vertical positions of the plurality of displays.

18. The system of claim 15, wherein inferring the physical arrangement comprises using artificial intelligence to infer the physical arrangement.

19. The system of claim 18, wherein the instructions further cause the at least one processor to enable a user to manually tune the inferred physical arrangement.

20. The system of claim 19, wherein the instructions further cause the at least one processor to use the manual tuning to further train the artificial intelligence.
